(19) United States
(12) Patent Application Publication
(10) Pub. No.: US 2016/0169426 A1
(43) Pub. Date: Jun. 16, 2016

(54) VARIABLE CROSS-SECTION TUBE PROFILE APPARATUS AND SYSTEM

(71) Applicant: United Technologies Corporation, Hartford, CT (US)

(72) Inventors: Jonas S. Banhos, New Haven, CT (US); Jonathan C. Reuben, West Hartford, CT (US)

(73) Assignee: UNITED TECHNOLOGIES CORPORATION, Hartford, CT (US)

(21) Appl. No.: 14/853,479

(22) Filed: Sep. 14, 2015

Related U.S. Application Data
(60) Provisional application No. 62/091,201, filed on Dec. 12, 2014.

(51) Int. Cl. F16L 21/00

(52) U.S. Cl. CPC F16L 21/00

(57) ABSTRACT

A variable cross-section tube adapter (VCSTA) is described herein. The VCSTA is configured to decrease bending stresses in high performance oval or circular tubes. Specifically, the VCSTA is configured decrease bending stresses in high performance oval or circular tubes between substantially the end of the tube and the housing and/or base to which the tube is coupled. A variable cross-section double wall tube (VCSDWT) profile is also described herein. For instance, VCSDWT may comprise an integral curved profile (bell shape) portion.

### CROSS-REFERENCE TO RELATED APPLICATIONS

This application is a nonprovisional of, and claims priority to, and the benefit of U.S. Provisional Application No. 62/091,201, entitled “VARIABLE CROSS-SECTION TUBE PROFILE APPARATUS AND SYSTEM,” filed on Dec. 12, 2014, which is hereby incorporated by reference in its entirety.

### FIELD OF INVENTION

The present disclosure relates generally to a tube for a fluid delivery system and more specifically to the profile of the outer tube for a fluid delivery system.

### BACKGROUND OF THE INVENTION

Various fluid delivery tubes are in the marketplace. These may include double wall tubes. A double wall tube is a secondary contained piping system. It is a pipe within a pipe, or encased in an outer covering, with an annulus (interstitial space) between the two diameters. The inner pipe is the primary or carrier pipe and the outer pipe is called the secondary or containment pipe. Fluid delivery tubes may comprise various cross sectional profiles.

### SUMMARY OF THE INVENTION

In various embodiments, a variable cross-section tube adapter includes a coupling portion. The variable cross-section tube adapter may include a first substantially constant perimeter length portion measured axially. The first substantially constant perimeter length portion may be adjacent to the coupling portion. The variable cross-section tube adapter may include a first increasing perimeter length portion measured axially. The first substantially constant perimeter length portion may be adjacent to the coupling portion. The variable cross-section tube adapter may include second substantially constant perimeter length portion measured axially. The second substantially constant perimeter length portion is adjacent to the first increasing perimeter length portion. The variable cross-section tube adapter may include a second increasing perimeter length portion measured axially. The second substantially constant perimeter length portion may be adjacent to the second substantially constant perimeter length portion. The variable cross-section tube adapter may include a distal end configured to couple to at least one of an adapter, a fitting, a tube, or a housing.

According to various embodiments, the coupling portion is configured to be coupled to an outer tube of a double wall tube or both an inner and outer wall. The first increasing perimeter length portion may be non-linear. A first wall thickness measurement of the variable cross-section tube adapter may be greater as measured at the coupling portion than a second wall thickness measurement as measured at the distal end. Any radial cut plane of the variable cross-section tube adapter forms an annulus. The variable cross-section tube adapter may include a pass through portion, wherein the pass through portion comprises a gradually increasing axial interior perimeter. The pass through portion is configured to receive a portion of an inner tube of a double wall tube. An opening of the pass through portion is at least one of elliptical, racetrack or circular. The variable cross-section tube adapter is configured to decrease bending stresses in at least one of high performance oval or circular tubes.

According to various embodiments, a variable cross-section double wall tube system is disclosed herein. The variable cross-section double wall tube may include an inner tube of substantially constant perimeter as measured axially. The variable cross-section double wall tube may include an outer or inner tube. The outer tube may comprise a substantially constant perimeter portion as measured axially. The outer tube may comprise a gradually increasing perimeter portion as measured axially adjacent to the substantially constant perimeter portion. The gradually increasing perimeter portion comprises a wall thickness. The wall thickness gradually decreases as measured axially from a junction of the gradually increasing perimeter portion and the substantially constant perimeter portion.

A first wall thickness of the outer tube wall is 80% at a distal end of the outer tube of a second wall thickness at the junction with the substantially constant perimeter portion. The perimeter of the outer tube increases by 25% at a distal end of the outer tube as compared with the perimeter at a junction of the gradually increasing perimeter portion with the substantially constant perimeter portion. The gradually increasing perimeter portion may be configured such that a varied area moment of inertia is achieved throughout the outer tube. The gradually increasing perimeter portion may be configured such that a uniform stress distribution is achieved throughout the gradually increasing perimeter portion.

According to various embodiments, a variable cross-section tube portion comprising; a substantially constant perimeter portion as measured axially and a gradually increasing perimeter portion as measured axially adjacent to the substantially constant perimeter portion is disclosed. The gradually increasing perimeter portion comprises a gradually decreasing tube wall thickness as measured axially. The variable cross-section tube portion is at least of an adapter or an outer tube of a double wall tube assembly.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates an isometric view of a variable cross-section tube adapter (“VCSTA”), in accordance with various embodiments;

FIG. 2 depicts an depicts a side cross-sectional axial view of a fluid delivery system comprising a VCSTA, in accordance with various embodiments;

FIG. 3A depicts an exploded view of a fluid delivery system comprising a VCSTA 100, in accordance with various embodiments;

FIG. 3B depicts a VCSTA 100, in accordance with various embodiments;

FIG. 4 depicts an isometric view of a fluid delivery system having an integral curved profile portion, in accordance with various embodiments;

FIG. 5A depicts a side cross-sectional axial view of a fluid delivery system having an integral curved profile portion, in accordance with various embodiments;

FIG. 5B depicts a top view of the fluid delivery system of FIG. 5A, in accordance with various embodiments;

FIG. 6 depicts a flared tube, in accordance with various embodiments; and

FIGS. 7 and 8 depict tube deflection vs. length graphs, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical changes and adaptations in design and construction may be made in accordance with this invention and the teachings herein. Thus, the detailed description herein is presented for purposes of illustration only and not of limitation. The scope of the invention is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Furthermore, any reference to singular includes plural embodiments, and any reference to more than one component or step may include a singular embodiment or step. Surface shading lines may be used throughout the figures to denote different parts but not necessarily to denote the same or different materials.

According to various embodiments, a variable cross-section tube adapter 100 (“VCSTA”) is disclosed. The VCSTA 100 is configured to decrease bending stresses in high performance oval, race track or circular tubes. Specifically, the VCSTA 100 is configured to decrease bending stresses in elliptical, racetrack, circular, oval, asymmetrical shape or a round radial cross-sectional profile double wall tubes between substantially the end of the double wall tube and the housing 240 and/or base to which the tube is coupled. The VCSTA 100 tube profile may be at least one of circular or non-circular. Any radial cut plane of the VCSTA 100 forms an annulus.

According to various embodiments, by varying area moment of inertia, a more uniform bending stress distribution is created throughout the coupled tube. This varying area moment of inertia may be achieved via creating a VCSTA 100 with a variable cross-section across its axis. For instance, VCSTA 100 may be a uniform part with curved profile or via a series of steps in the profile and/or a combination thereof.

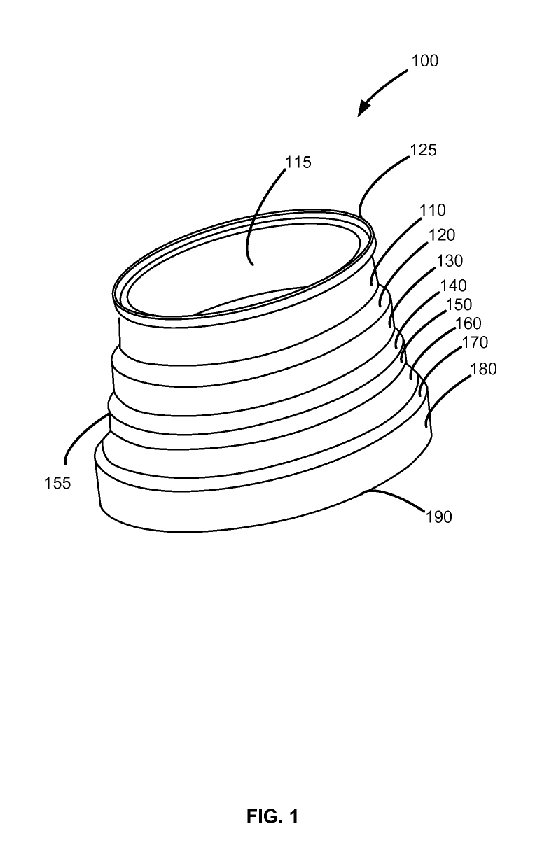

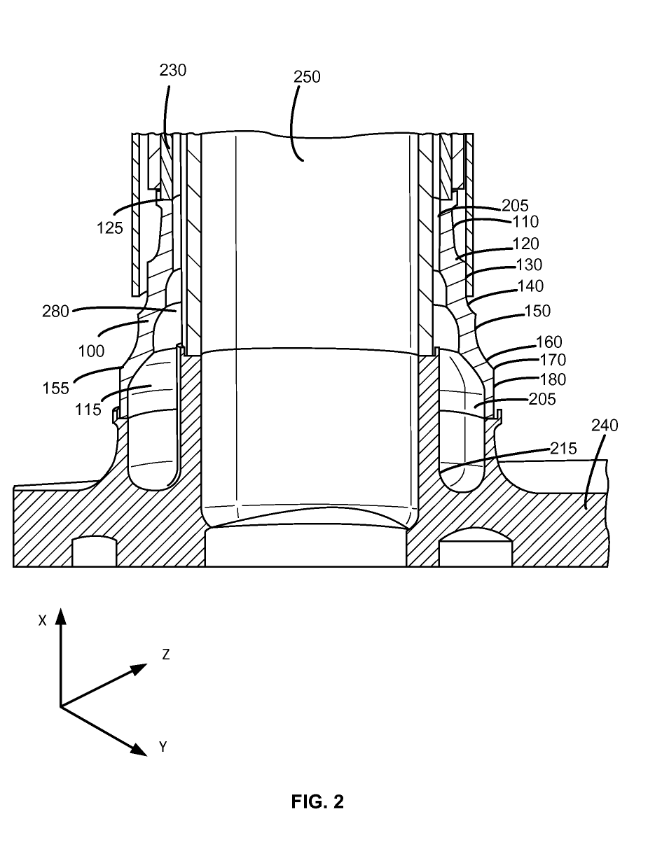

In various embodiments, and with reference to FIG. 1, VCSTA 100 comprises a 3 step design. For instance, VCSTA 100 may comprise a perimeter that substantially matches the perimeter of a tube to which it is coupled. The tube may be an outer tube 230 (as shown in FIG. 2) of a double wall tube. VCSTA 100 may comprise a gradually graduated perimeter measured axially (such as along axis Z) from the junction of the coupling location (coupling portion 125) to the distal end 190 of VCSTA 100. Stated another way, VCSTA 100 may comprise a non-linear increasing radial geometry having a series of generally angled portions of increasing perimeter size and generally constant perimeter portions measured axially from the junction of the coupling location (coupling portion 125) to the distal end 190 of VCSTA 100.

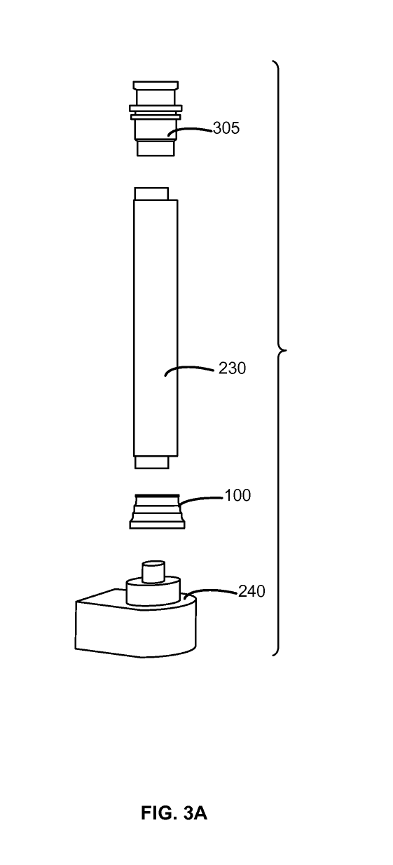

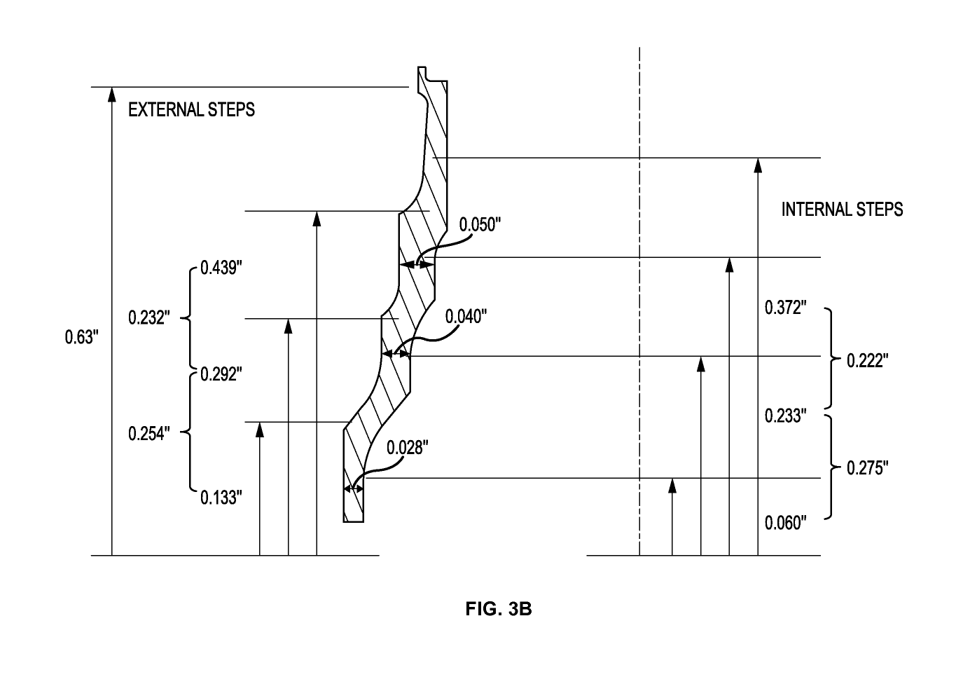

For instance, VCSTA 100 may comprise a first portion 110 located substantially adjacent and/or distal to a coupling portion 125 of the outer tube 230 (see also FIGS. 2 and 3A). First portion 110 may comprise a cross-sectional radial profile and perimeter that is substantially equivalent to the cross-sectional radial profile and perimeter at the coupling portion 125. Adjacent to first portion 110 may be a first angled portion 120 having an increasing perimeter as compared with the perimeter of the first portion 110. First angled portion 120 may transition to a second portion 130 having a substantially concentric larger perimeter to the perimeter of first portion 110. Second portion 130 may comprise a generally constant perimeter.

Adjacent to second portion 130 may be a second angled portion 140 having an increasing perimeter as compared with the perimeter of second portion 130. Second angled portion 140 may transition to a third portion 150 having a substantially concentric larger perimeter to the perimeter of second portion 130. Third portion 150 may comprise a generally constant perimeter.

Adjacent to third portion 150 may be a third angled portion 160 having an increasing perimeter as compared with the perimeter of third portion 150. Third portion 150 may transition to at least one of a beveled edge 170 and/or a fourth portion 180. Fourth portion 180 may comprise a concentric larger perimeter as compared with the perimeter of third portion 150. Fourth portion 180 may comprise a generally constant perimeter. Fourth portion 180 may transition to distal end 190. Distal end 190 may be coupled to another tube, a housing 240 (As depicted in FIG. 2), and/or adapter.

VCSTA 100 may comprise a pass through portion 115. Pass through portion 115 may comprise a gradually increasing radial cross-section measured from 125 to distal end 190. Stated another way, the pass through portion 115 comprises a gradually increasing axial interior perimeter. Pass through portion 115 may be configured to receive at least a portion of an inner tube 250 of a double wall tube (with brief reference to FIG. 2). The wall of VCSTA 100 may be generally thinner between the exterior surface 155 of VCSTA 100 and the interior surface 280 (as shown in FIG. 2) of VCSTA 100 (VCSTA 100 side wall) measured axially from distal end 190 to the coupling portion 125. In this way, in some contexts, VCSTA 100 may act as a spring as VCSTA 100 wall thins between an interior surface 280 and an exterior surface 155 from top (coupling portion 125) to bottom (distal end 190).

A VCSTA 100 with a variable cross-section may be configured to distribute a bending stress so that instead of any one particular area experiencing a high level of bending, a variable cross-section assists with distribution of the bending stress to different discrete areas so that no one particular area has an undesired amount of stress, such as a bending stress from displacement loading, exerted by at least one of the weight of the double wall tube and/or a load on a portion of the double wall tube.

According to various embodiments, and with reference to FIG. 2, VCSTA 100 may be part of a fluid delivery system. For instance, the outer tube 230 of a double wall tube may be configured to couple to coupling portion 125. Outer tube 230 may be coupled to coupling portion 125 via any suitable means. For instance, outer tube 230 may be integrally formed with VCSTA 100 or outer tube 230 may be welded to VCSTA 100 at coupling portion 125. Outer tube 230 may be bonded to VCSTA 100. As desired any type of tube may be coupled to VCSTA 100.

An inner tube 250 of a double wall tube may be configured to pass through at least a portion of pass through portion 115. The radial cross sectional area of inner tube 250 may be substantially constant or could follow similar progression of perimeter area as previously described for the outer tube. An air gap 205 may be formed between the exterior surface 155 of inner tube 250 and the interior surface 280 of VCSTA 100. According to various embodiments an insulation material, such as ceramic fibers, may be at least partially disposed between exterior surface of inner tube 250 and the interior surface 280 of VCSTA 100.

According to various embodiments, the steps formed in the exterior surface of VCSTA 100 may comprise a series of curves interposed with a series of generally planar surface features.

VCSTA 100 may be bolted to a housing, such as housing 240. VCSTA 100 may be bolted to a housing 240 via a flange. VCSTA 100 may be made from any suitable material. For instance, VCSTA 100 may be made from a metal, such as steel, an alloy, such as an austenitic nickel-chromium-based superalloy. A portion 215 of housing 240 may extend into at least a portion of pass through portion 115 of VCSTA 100. The portion of housing 240 extending up into pass through portion 115 of VCSTA 100 may be coupled with the inner tube 250 of the double wall tube, such as via welding.

According to various embodiments and with brief reference to FIG. 3A, the double wall tube, such as via outer tube 230, may be coupled to VCSTA 100 at the coupling portion 125. VCSTA 100 may be coupled to a housing 240. A fitting 305, second adaptor or second tube may be coupled to the double wall tube, such as via at least one of inner tube 250 and/or outer tube 230. According to various embodiments, coupling portion 125 of VCSTA 100 may be coupled to any desired structure, such as a tube, such as a double wall tube, a fitting, an adapter, a hose, housing and/or the like.

According to various embodiments and with brief reference to FIG. 3B a representative VCSTA 100 is illustrated. Here, 3 vertical section are shown of a circular profile double wall tube. The average normalized step difference is 0.246 inches (0.6248 centimeter), or about 0.250 inches (about 0.635 centimeter). Stress =F*(L−h)*(0R)/(I), for I=moment of inertia Thus: removing Force (F) from equation returns a constant value for the setting: Constant=(L−h)*(OR)/(I). The results in table 1 below illustrate about 10% variation in between steps. As shown, the device comprises constant steps leading to progressively thinner wall thickness sections at larger diameter. In this case, the step thickness may be 0.050 inches (0.127 centimeter), 0.040 inches (0.1016 centimeter) and 0.028 inches (0.07112 centimeter).

The “steps” may not have constant thicknesses. The steps are in general, substantially equally spaced. Note step differences may be normalized. For instance, (Step1 Height−Step2 Height)/Adapter Length) Such as (0.439 inches (1.115 centimeters)−0.292 inches (0.7417 centimeter))/0.63 inches (1.6 centimeters)=0.232 inches (0.5893 centimeter) as shown.

TABLE 1

| Base Run, Uniform thickness 0.028 inches (0.07112 centimeter), Circular Profile, | | | | | CONSTANT | Approx. |
|---|---|---|---|---|---|---|
| h | L | OR | IR | I | OR*(L − h)/I | Constant |
| 0.37 inches | 7.00 inches | 0.343 inches | 0.293 inches | 0.005082 inches | 447 | 0.917968 |
| (0.9398 centimeter) | (17.78 centimeters) | (0.8712 centimeter) | (0.7442 centimeter) | (0.01291 centimeter) | | |
| 0.23 inches | 7.00 inches | 0.368 inches | 0.328 inches | 0.005313 inches | 469 | 0.961934 |
| (0.5842 centimeter) | (17.78 centimeters) | (0.9347 centimeter) | (0.8331 centimeter) | (0.0135 centimeter) | | |
| 0.06 inches | 7.00 inches | 0.423 inches | 0.395 inches | 0.006025 inches | 487 | |
| (0.1524 centimeter) | (17.78 centimeters) | (1.074 centimeter) | (1.003 centimeters) | (0.0153 centimeter) | | |

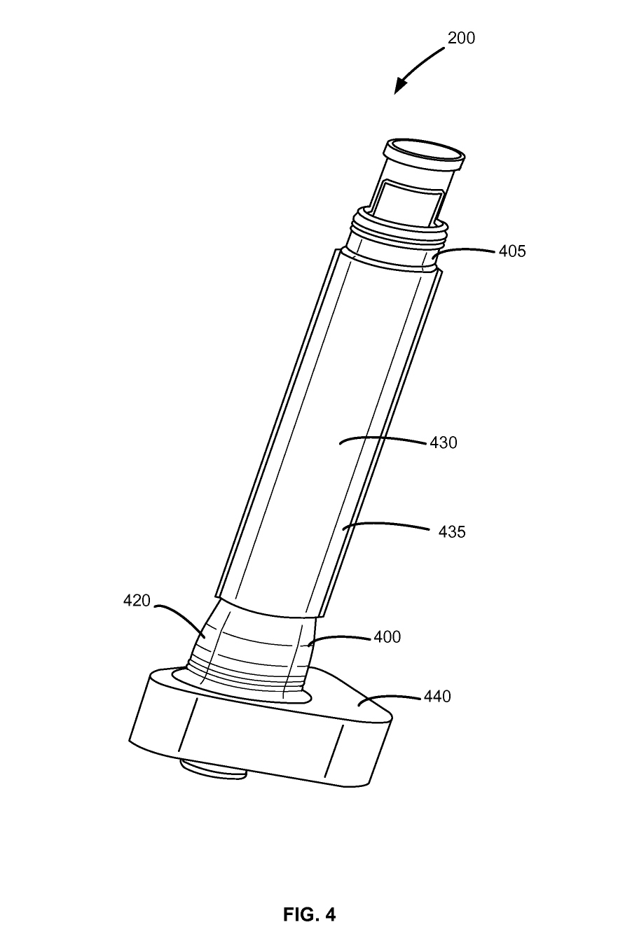

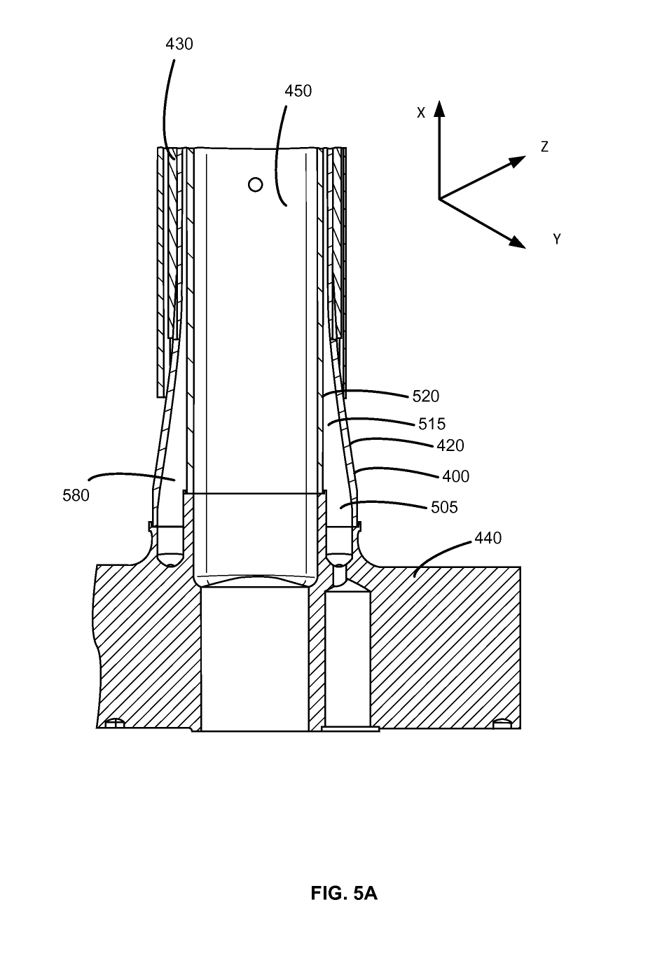

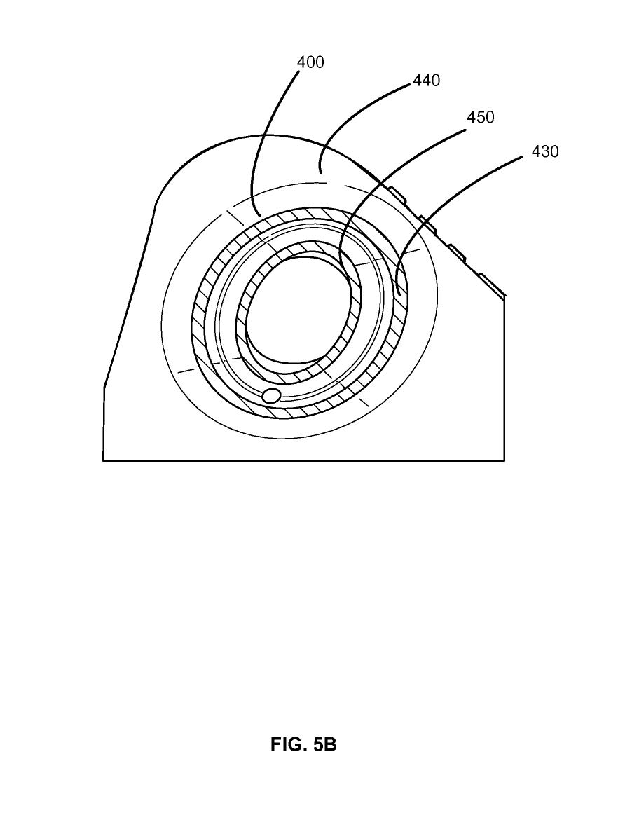

According to various embodiments and with reference to FIG. 4, a variable cross-section double wall tube 200 (VCSDWT) profile is disclosed. For instance, the VCSDWT 200 may be configured such that bending stresses are decreased in the wall of the outer tube 430 of the high performance double wall tube. Varying area moment of inertia allows a more uniform stress distribution throughout the VCSDWT 200. For instance, VCSDWT 200 may comprise a curved profile (bell shape) portion 400. The curved profile portion 400 of the outer tube 430 may be integrally formed with a substantially uniform perimeter profile portion 435 of the outer tube 430. In this way, an integral outer tube 430 of a double wall tube may be formed. The curved profile portion 400 of the outer tube 430 may be coupled to a housing 440. The surface 420 of the curved profile portion 400 of the outer tube 430 may flare from more narrow near the intersection of the constant profile portion 435 of the outer tube 430 to wide at the transition to the housing 440. A fitting 405, second adaptor or second tube may be coupled to the double wall tube, such as via at least one of inner tube 450 (with brief reference to FIG. 5A) and/or outer tube 430.

According to various embodiments and with reference to FIG. 5A, an axial cross-sectional view of VCSDWT 200 is depicted. VCSDWT 200 may be part of a fluid delivery system. The fluid delivery system may comprise an outer tube 430 and inner tube 450 of a double wall tube. Outer tube 430 may be integrally formed with the curved profile portion 400.

An inner tube 450 of a double wall tube may be configured to pass through at least a portion of a pass through portion 515 of the curved profile portion 400. The radial cross sectional area of inner tube 450 may be substantially constant. An air gap 505 may be formed between the exterior surface 520 of inner tube 450 and the interior surface 580 of the curved profile portion 400. According to various embodiments an insulation material may be at least partially disposed between exterior surface 520 of inner tube 450 and the interior surface 580 of the curved profile portion 400.

According to various embodiments, the width of the wall of the inner tube 450 along the substantially constant profile portion 435 may be 0.035 inch (0.0889 centimeter) thickness. This thickness may gradually decrease in the curved profile portion 400 of the outer tube 430 measuring from the substantially constant profile portion 435 (as shown in FIG. 4) to the junction with the housing 440. For instance, as the end of the outer tube 430 is made wider and increases in diameter, the outer tube 430 wall width is decreases. According to various embodiments, the base of the curved profile portion 400 of the outer tube 430 is one and a half inches. At the junction of the substantially constant profile portion 435 the wall width may be 0.035 inches (0.0889 centimeter) while the wall width at the base (where the curved profile portion 400 is coupled to the housing 440) of the curved profile portion 400 may be 0.028 inches (0.07112 centimeter). In this way, the thickness of the wall is 80% at the base of the thickness at the junction with the constant profile portion 435. The circumference of the outer tube 430 may increase 25% as compared with the circumference at the junction with the constant profile portion 435. The axial length of the curved profile portion 400 may be any desired length. For instance, the axial length of the curved profile portion 400 between the junction with the constant profile portion 435 and the distal end may be about 2 inches (about 5.08 centimeters). For instance, the axial length of the curved profile portion 400 between the junction with the constant profile portion 435 and the distal end may be between about 1 and 6 inches (about 2.54 and 15.24 centimeters), between about 1 and 4 inches (about 2.54 and 10.16 centimeters), and between about 1.5 and 2.5 inches (about 3.81 and 6.35 centimeters).

The ratio between the length of the curved profile portion and the interior diameter is about 4:1 and length to exterior diameter is about 2:1. The thickness change may be inversely proportional to the increase in diameter. The axial length of the curved profile portion may be dependent on boundary conditions, tube diameter and displacements. For a tube with free-fixed boundary conditions the tube length required needs to be more than (√((3×E×OD×6) /(2×Strn))/1.2.
Where: E=Modulus of Elasticity
OD=Outer Diameter of the tube
δ=deflection of the tube
Strn=Fatigue Strength for life desired

According to various embodiments the ratio of a diameter of the substantially constant perimeter length portion as compared to a diameter of the substantially constant perimeter length portion is no larger than the strain capability of the material. For example, for Inconel-625 this ratio should be about 1.35. An axial length to a wall thickness ratio is between about 100:1 and about 25:1.

According to various embodiments, a constant cross-sectional area is maintained at any position along the axial length of the outer tube 430. The end of the outer tube 430 may be expanded with a specially shaped flare tool though an applied force.

According to various embodiments, the curved profile portion 400 may be formed separately from the constant profile portion 435 of the outer tube 430. These two portions may then be jointed together through any desired process. For instance, a constant profile portion 435 may be welded to a separate curved profile portion 400.

According to various embodiments and with renewed reference to FIG. 5A, an air gap is formed between the interior surface of the curved profile portion 400 and the exterior surface 520 of inner tube 550450. Insulation may partially fill this air gap. FIG. 5B, depicts the top view of the fluid delivery system of FIG. 5A. VCSDWT 200 may comprise an elliptical, racetrack, circular, oval, asymmetrical shape or a round radial cross-sectional profile. The VCSDWT 200 tube profile may be at least one of circular or non-circular.

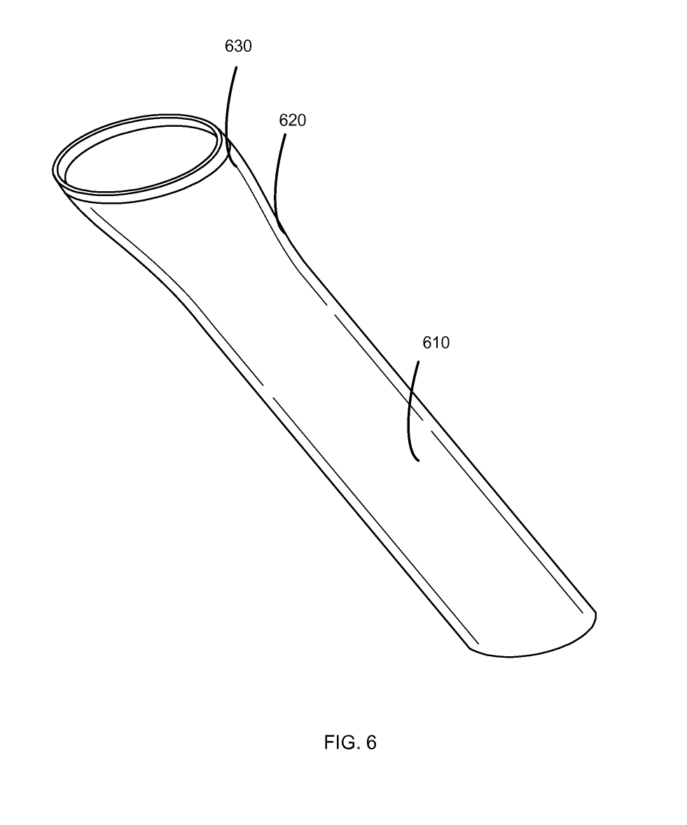

According to various embodiments and with reference to FIG. 6 a flared tube is depicted. The top end has been expanded by use of a die impacted into the tube end. The tube may then be shaped into an oval shape. Flaring can work with round, oval, race track, circular or non-circular tube shapes. The various sections of the tube comprise a straight section 610, tangency section 620 and the radius section 630. The limit of expansion of the tube is generally tied to the elongation capability of the material. The tangency section 620 may be between radius section 630 and the straight section 610, approximately 25% to about 33% the axial length of the tube. The radius is equal to approximately the diameter of the tube. Flaring of tubes is recommended to be used in cases where there are high stresses due to fatigue bending. One or both ends of the tube may be flared based on the loading conditions and resultant stress distribution.

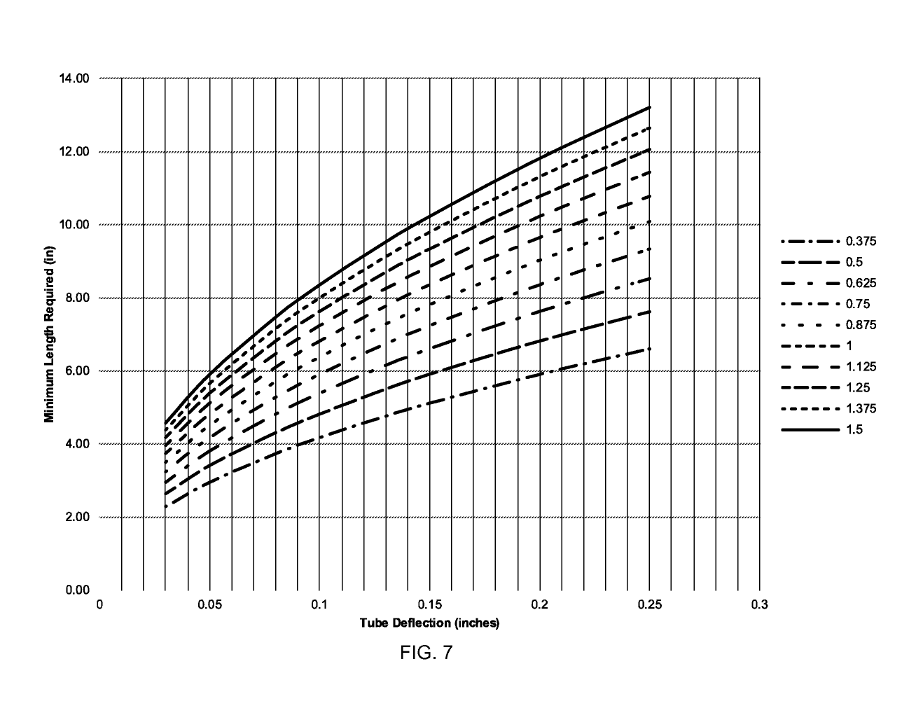

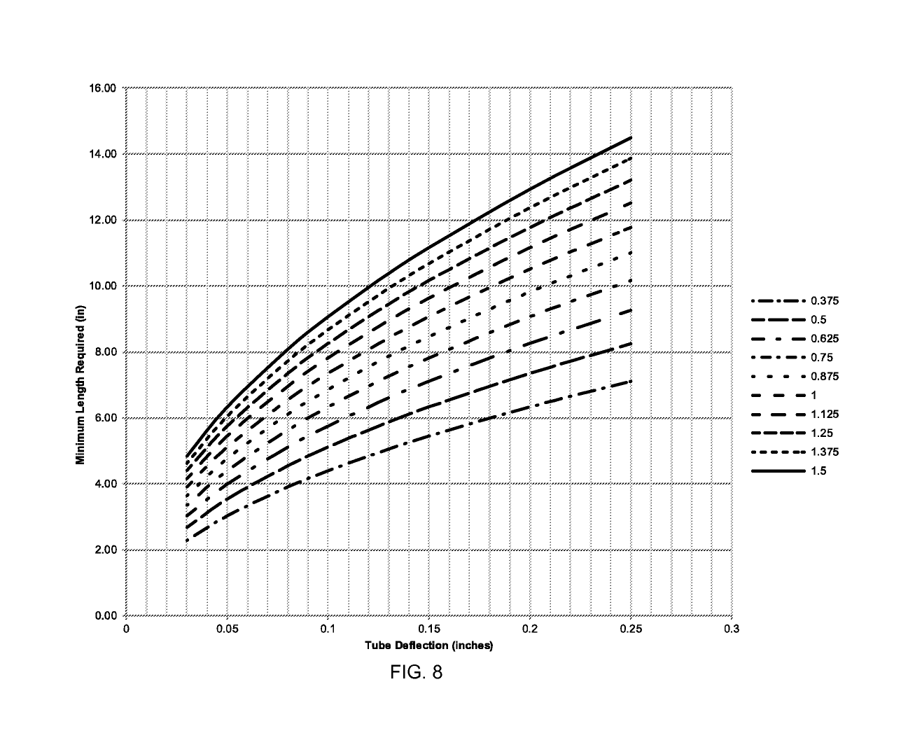

According to various embodiments and with reference to FIGS. 7 and 8 the axial length of a flared portion may be determined based on a set of known conditions. For example, the length, diameter, cyclic movement and life requirements of the tube may be known factors. Based on the tube movement and the appropriate tube diameter curve, the minimum required length of the tube to avoid flaring may be determined. If the tube does not satisfy the requirement and the tube is no less than 20% shorter than the required length, flaring can be used. In this way, flaring may bring stresses down to satisfactory levels. If the tube is too short, additional tubes of a smaller diameter may be utilized to satisfy flow constraints. FIG. 7 may relate to an inner tube. FIG. 8 may be associated with an outer tube.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A variable cross-section tube adapter having an axis comprising:
a coupling portion;
a first substantially constant perimeter length portion measured axially of a variable cross-section tube centerline axis, wherein the first substantially constant perimeter length portion is distal to the coupling portion;
a first increasing perimeter length portion measured axially, wherein the first substantially constant perimeter length portion is adjacent to the coupling portion;
a second substantially constant perimeter length portion measured axially, wherein the second substantially constant perimeter length portion is adjacent to the first increasing perimeter length portion; and
a second increasing perimeter length portion measured axially, wherein the second substantially constant perimeter length portion is adjacent to the second substantially constant perimeter length portion.

2. The variable cross-section tube adapter of claim 1, wherein the coupling portion is configured to be coupled to an outer tube of a double wall tube.

3. The variable cross-section tube adapter of claim 1, wherein the first increasing perimeter length portion is non-linear.

4. The variable cross-section tube adapter of claim 1, further comprising a distal end configured to couple to at least one of an adapter, a fitting, a tube, or a housing.

5. The variable cross-section tube adapter of claim 4, wherein a first wall thickness measurement of the variable cross-section tube adapter is greater as measured at the coupling portion than a second wall thickness measurement as measured at the distal end.

6. The variable cross-section tube adapter of claim 1, wherein any radial cut plane of the variable cross-section tube adapter forms an annulus.

7. The variable cross-section tube adapter of claim 1, further comprising a pass through portion, wherein the pass through portion comprises a gradually increasing axial interior perimeter.

8. The variable cross-section tube adapter of claim 7, wherein the pass through portion is configured to receive a portion of an inner tube of a double wall tube.

9. The variable cross-section tube adapter of claim 7, wherein an opening of the pass through portion is at least one of elliptical, racetrack or circular.

10. The variable cross-section tube adapter of claim 1, wherein the ratio of a diameter of the second increasing perimeter length portion as compared to a diameter of the substantially constant perimeter length portion is no larger than the strain capability of the material.

11. The variable cross-section tube adapter of claim 1, wherein an axial length to a wall thickness ratio is between about 100:1 and about 25:1.

12. The variable cross-section tube adapter of claim 1, wherein the variable cross-section tube adapter is configured to decrease bending stresses in at least one of high performance oval or circular tubes.

13. A variable cross-section double wall tube system comprising:
an inner tube of substantially constant perimeter as measured axially of variable cross-section double wall tube system centerline axis; and
an outer tube comprising:
a substantially constant perimeter portion as measured axially; and
a gradually increasing perimeter portion as measured axially adjacent to the substantially constant perimeter portion, wherein the gradually increasing perimeter portion comprises a wall thickness, wherein the wall thickness gradually decreases as measured axially from a junction of the gradually increasing perimeter portion and the substantially constant perimeter portion.

14. The variable cross-section double wall tube system of claim 13, wherein a constant cross-sectional area is maintained at any position along an axial length of the outer tube.

15. The variable cross-section double wall tube system of claim 13, wherein a first wall thickness of the outer tube is 80% at a distal end of the outer tube of a second wall thickness at the junction with the substantially constant perimeter portion.

16. The variable cross-section double wall tube system of claim 13, wherein a perimeter of the outer tube increases by 25% at a distal end of the outer tube as compared with a perimeter at the junction.

17. The variable cross-section double wall tube system of claim 13, the gradually increasing perimeter portion is configured such that a varied area moment of inertia is achieved throughout the outer tube.

18. The variable cross-section double wall tube system of claim 13, the gradually increasing perimeter portion is configured such that a uniform stress distribution is achieved throughout the gradually increasing perimeter portion.

19. A variable cross-section tube portion comprising;
a substantially constant perimeter portion as measured axially; and
a gradually increasing perimeter portion as measured axially adjacent to the substantially constant perimeter portion, wherein the gradually increasing perimeter portion comprises a gradually decreasing tube wall thickness as measured axially.

20. The variable cross-section tube portion of claim 19, wherein the variable cross-section tube portion is at least of an adapter or an outer tube of a double wall tube assembly.
